(19) United States
(12) Patent Application Publication
(10) Pub. No.: US 2024/0202541 A1
(43) Pub. Date: Jun. 20, 2024

(54) INFORMATION PROCESSING APPARATUS, INFORMATION PROCESSING METHOD, AND STORAGE MEDIUM STORING PROGRAM

(71) Applicant: CANON KABUSHIKI KAISHA, Tokyo (JP)

(72) Inventor: KOICHI TANJI, Kanagawa (JP)

(21) Appl. No.: 18/537,572

(22) Filed: Dec. 12, 2023

(30) Foreign Application Priority Data
Dec. 14, 2022 (JP) 2022-199426

(51) Int. Cl. G06N 3/096; G06F 21/60; G06N 3/045

(52) U.S. Cl. CPC G06N 3/096; G06F 21/602; G06N 3/045

(57) ABSTRACT

An information processing apparatus includes one or more processors, and one or more memories that store a computer-readable instruction configured to be executed by the one or more processors, thereby the computer-readable instruction causing the information processing apparatus to divide parameter data related to a network model of a neural network into a plurality of blocks, and generate embedded information based on connection information for each block obtained by converting, for the respective blocks, data in each block including the parameter data and connection information for another block, and perform output setting for using data with the generated embedded information embedded in an output from the network model, as an output of the network model.

### BACKGROUND

### Field of the Disclosure

The present disclosure relates to an information processing apparatus, an information processing method, and a storage medium storing a program.

### Description of the Related Art

In recent years, hierarchical networks such as convolutional neural networks (CNNs) have attracted attention because of the high performance of network models after learning in the field of machine learning. A document (“ImageNet classification with deep convolutional neural networks”, A. Krizhevsky et al. (NIPS2012)) discusses a technique related to a CNN.

Learning refers to inputting teacher data to a hierarchical network, performing back propagation of an output value error obtained as a result of forward propagation calculation in the network, and sequentially and repeatedly updating weight coefficients corresponding to the network link state and other parameters. Teacher data refers to a desirable output (label value or its distribution) for input data. In the above-described learning, learning is performed by using learning data including the input data and the teacher data. A network model refers to a hierarchical network that has completed learning in this manner. The network model inputs predetermined data such as image data and outputs predetermined data such as a classification result through the forward propagation calculation. The network model includes parameter data such as a weight coefficient and information about the configuration of the hierarchical network (architecture coefficient). The weight coefficient is also referred to as a model parameter, and the architecture coefficient is also referred to as an architecture parameter.

Hierarchical networks such as CNNs have been studied for diverse applications such as automatic driving, monitoring with network cameras, face recognition for security measures, and medical diagnosis assistance, increasing their importance as social infrastructures. Accordingly, it has become important to protect intellectual properties of network models and prevent the misappropriation (plaglarism), and more particularly in mission-critical applications, to defend network models against adversarial attacks.

A document (“Threat of adversarial attacks on deep learning in computer vision: A survey”, N. Akhtar and A. Mian. (IEEE Access 2018)) reports an example case of an adversarial attack for applying unperceivable disturbances to an input image to largely change a result, e.g., a classification result obtained by inputting the input image to a network model from a result to be originally obtained. However, only defensive measures against disturbances to the input image discussed in this document cannot prevent adversarial attacks that alter a parameter itself of the network model. If a parameter itself of the network model is altered, the network model degrades in performance and becomes unable to perform its original functions, possibly causing a problem.

A document (“DeepRing: Protecting Deep Neural Network with Blockchain”, A. Goel et al. (CVPR2019)) discusses a method for defending a parameter itself of a network model by dividing a network model into blocks for each layer and blockchaining the blocks at random to prevent alteration of the parameter itself of the network model. Blockchaining refers to dividing the entire data into blocks each having fixed data pieces and linking the blocks based on hash values corresponding to respective blocks. A hash value is generated by converting original data into data with a fixed length shorter than the length of the original data. The configuration where blocks are linked with each other via hash values has an advantage of easiness of detecting a data alteration because, if a certain block is altered, the hash values of all blocks linked with the altered block change.

However, even if this method can prevent an alteration of a network model, the method cannot prevent the misappropriation of the network model because another network model can be newly learned and generated by using the output of the network model through distillation learning. For the distillation learning, see a document (“Distilling the Knowledge in a Neural Network”, G. Hinton et al. (NIPS2014)). Generally in the distillation learning, a lighter network model (referred to as a student model) having lower performance is learned and generated by using as teacher data the output of a network model (referred to as a teacher model) having a larger scale and higher accuracy. A document (“Born-Again Neural Networks”, Tommaso Furlanello et al. (ICML2018)) discusses a method for performing the distillation learning without changing the network size to prevent performance degradation.

If such distillation learning is performed, it may become impossible to protect intellectual properties of a network model and prevent the misappropriation of the network model.

### SUMMARY

According to an aspect of the present disclosure, an information processing apparatus includes one or more processors, and one or more memories that store a computer-readable instruction configured to be executed by the one or more processors, thereby the computer-readable instruction causing the information processing apparatus to divide parameter data related to a network model of a neural network into a plurality of blocks, and generate embedded information based on connection information for each block obtained by converting, for the respective blocks, data in each block including the parameter data and connection information for another block, and perform output setting for using data with the generated embedded information embedded in an output from the network model, as an output of the network model.

Further features of the present disclosure will become apparent from the following description of exemplary embodiments with reference to the attached drawings.

### BRIEF DESCRIPTION OF THE DRAWINGS

FIG. 1 illustrates an example of a configuration of an information processing apparatus.

FIG. 2 illustrates an example of a hardware configuration of the information processing apparatus.

FIG. 3 is a flowchart illustrating processing performed by the information processing apparatus.

FIG. 4 illustrates a block chain.

FIG. 5 illustrates a network model.

FIG. 6 illustrates block chaining of a network model.

FIG. 7 illustrates an example of embedded information generation processing.

FIG. 8 illustrates distillation learning.

FIGS. 9A and 9B illustrate an example of preventing the misappropriation of a network model.

FIG. 10 illustrates another example of preventing the misappropriation of a network model.

FIG. 11 illustrates still another example of preventing the misappropriation of a network model.

### DESCRIPTION OF THE EMBODIMENTS

Exemplary embodiments of the present disclosure will be described below with reference to the accompanying drawings. The following exemplary embodiments are to be merely considered as illustrative, and the present disclosure is not limited to the following exemplary embodiments.

A first exemplary embodiment will be described below centering on an example of dividing parameter data related to a network model into a plurality of blocks, blockchaining the network model, and embedding hash values from blocks in the output data of the network model. Performing block chaining of a network model and embedding hash values from blocks in the output data of the network model enables preventing the misappropriation of the network model by a distillation learning technique.

Examples of network models include network models of hierarchical networks such as convolutional neural networks (CNNs). A network model includes parameters such as a weight coefficient corresponding to the network link state and configuration information (architecture coefficient) indicating the network configuration. An example of a network model will be described below. This example prevents the network model from being subjected to the distillation learning by using a 10-classification model CNN including 12 layers. The CNN may be a learned model for performing image recognition, a model for performing video or audio noise reduction, or a model for keyword-based image generation.

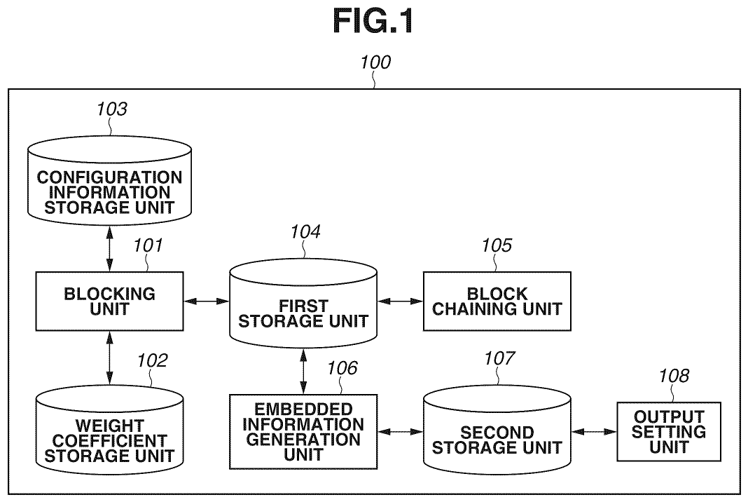

FIG. 1 is a block diagram illustrating an example configuration of an information processing apparatus 100 according to a first exemplary embodiment. The information processing apparatus 100 includes a blocking unit 101, a weight coefficient storage unit 102, a configuration information storage unit 103, a first storage unit 104, a block chaining unit 105, an embedded information generation unit 106, a second storage unit 107, and an output setting unit 108.

The blocking unit 101 divides the parameter data related to a network model into a plurality of component units (blocks) of a block chain. The blocking unit 101 reads data of the network model including a weight coefficient and configuration information (architecture coefficient) from the weight coefficient storage unit 102 and the configuration information storage unit 103, respectively, and divides the data into a plurality of blocks. The parameter data related to the network model having been divided into blocks is output to the first storage unit 104 and held therein.

For example, the blocking unit 101 divides the data of the network model into blocks for each layer in a neural network. The blocking unit 101 may divide the data of the network model into blocks for each of a plurality of layers in the neural network, or divide the data of the network model for one layer into a plurality of blocks. With a neural network having a prescribed configuration, the blocking unit 101 may divide only the data of the weight coefficient into a plurality of blocks as a parameter related to the network model, without including the configuration information (architecture coefficient).

The weight coefficient storage unit 102 holds information about the weight coefficient of the network model.

The information about the weight coefficient held by the weight coefficient storage unit 102 includes, for example, a weight value, a bias value, information about an activation function, and the like. The configuration information storage unit 103 holds the configuration information (information about the architecture coefficient) indicating the configuration of the network model.

The first storage unit 104 holds the parameter data related to the network model having been divided into blocks by the blocking unit 101. The first storage unit 104 also holds the data related to the network model blockchained by the block chaining unit 105.

The block chaining unit 105 calculates hash values of blocks based on the parameter data related to the network model having been divided into a plurality of blocks to blockchain the network model. The block chaining unit 105 is an example of a conversion unit, and a hash value is an example of connection information. The block chaining unit 105 repetitively performs a sequence of reading the data of a block from the first storage unit 104, calculating the hash value of the block, and appending the hash value to the data of the following block. As a result of this series of operations, the data of the network model is blockchained, output to the first storage unit 104 again, and held therein.

More specifically, the block chaining unit 105 converts, for each block, block data including the parameter data related to the network model and the hash value of the preceding block as the connection information for another block, into a hash value by using a hash function. Then, the block chaining unit 105 adds the obtained hash value to the data of the following block. The block chaining unit 105 sequentially performs this processing for the respective blocks to blockchain the data of the network model.

The embedded information generation unit 106 generates embedded information based on the hash values of blocks obtained by converting the data of respective blocks via the block chaining unit 105. The embedded information generation unit 106 is an example of a generation unit. The embedded information generation unit 106 reads the hash values of blocks from the first storage unit 104 and generates information to be embedded in the output of the network model based on the read hash value. The embedded information generation unit 106 generates embedded information corresponding to the format of the output of the network model. The generated embedded information is output to the second storage unit 107 and held therein. The embedded information generation unit 106 also generates information about the embedded information generation, i.e., information indicating how the embedded information is generated from the read hash value.

The output setting unit 108 embeds the generated embedded information in the output data of the network model. The output setting unit 108 is an example of an output setting unit. The output setting unit 108 reads the embedded information from the second storage unit 107 and embeds it in the output from the network model, and outputs the output from the network model having the embedded information, as the output data of the network model. The output setting unit 108 embeds the embedded information in the output from the network model for each input data. The output from the network model subjected to embedding of the embedded information is, for example, a softmax output corresponding to the input data from the network model. The output from the network model subjected to embedding of the embedded information may be an output (what is called a logits output) before being input to a softmax function. For example, the output from the relevant network model may be a feature quantity output from the network model if the network model performs the comparison of the feature quantity of a face recognition task.

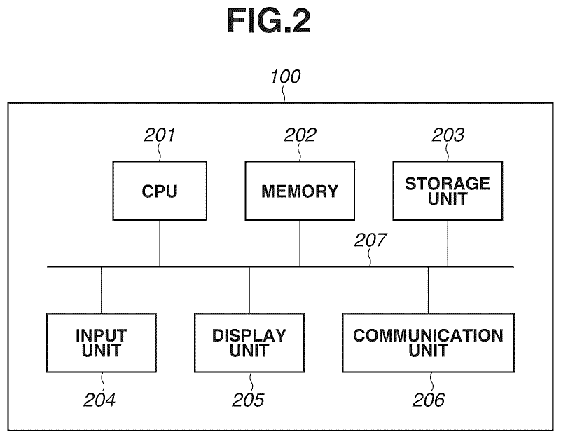

FIG. 2 is a block diagram illustrating an example of a hardware configuration of the information processing apparatus 100 according to the present exemplary embodiment. The information processing apparatus 100 includes a central processing unit (CPU) 201, a memory 202, a storage unit 203, an input unit 204, a display unit 205, a communication unit 206, and a system bus 207. The CPU 201, the memory 202, the storage unit 203, the input unit 204, the display unit 205, and the communication unit 206 are communicably connected with each other via the system bus 207. The information processing apparatus 100 according to the present exemplary embodiment may further include other components.

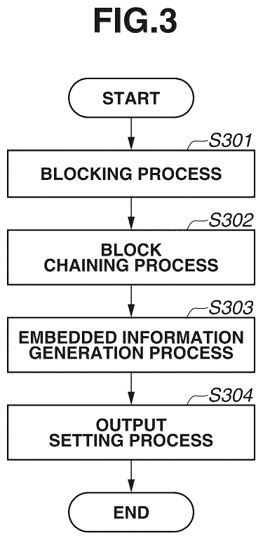

The CPU 201 controls the entire information processing apparatus 100. The CPU 201 controls the operation of each function unit connected, for example, via the system bus 207. A graphics processing unit (GPU) may be used instead of the CPU. The memory 202 stores data and programs to be used for processing by the CPU 201. The memory 202 functions as the main memory of the CPU 201 and a work area. When the CPU 201 performs processing based on programs stored in the memory 202, the configuration of the information processing apparatus 100 illustrated in FIG. 1 and the processing of the flowchart in FIG. 3 (described below) are implemented.

For example, the storage unit 203 stores various kinds of data used when the CPU 201 performs processing related to programs. For example, the storage unit 203 stores various kinds of data obtained when the CPU 201 performs processing related to programs. The data and programs to be used for processing by the CPU 201 are stored in the storage unit 203. The input unit 204 having operating members such as the mouse and buttons inputs user operations to the information processing apparatus 100. The display unit 205 having a display member such as a liquid crystal display displays a result of processing by the CPU 201. The communication unit 206 connects the information processing apparatus 100 to a network and controls communications with other apparatuses.

Processing performed by the information processing apparatus 100 according to the present exemplary embodiment will be described below with reference to the flowchart in FIG. 3. FIG. 3 is a flowchart illustrating processing performed by the information processing apparatus 100 according to the present exemplary embodiment.

In step S301, the blocking unit 101 divides the parameter data related to the network model into a plurality of component units (blocks) of a block chain. The blocking unit 101 reads the data of the network model from the weight coefficient storage unit 102 and the configuration information storage unit 103 and divides the data into a plurality of blocks. The parameter data related to the network model having been divided into blocks is output to the first storage unit 104.

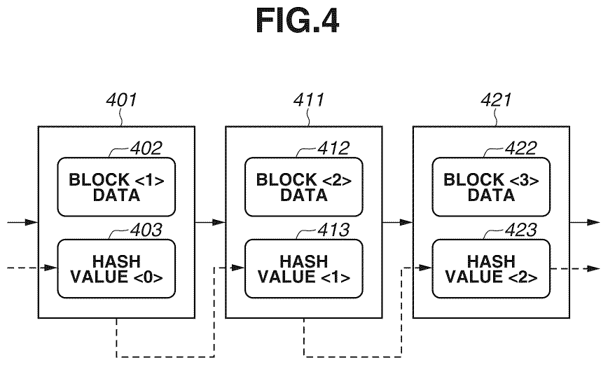

A block chain will be described below with reference to FIG. 4. FIG. 4 is a conceptual schematic view illustrating a block chain. FIG. 4 illustrates a state where three respective blocks (blocks 401, 411, and 421) configuring a block chain are sequentially linked.

As illustrated in FIG. 4, a block 401 stores block <1> data 402 and a hash value <0> 403. The block <1> data 402 associates part of division data of the entire data with the block 401. The hash value <0> 403 is calculated based on the data in the preceding block linked with the block 401. A hash value refers to data generated from the original data through conversion, having a fixed length shorter than the length of the original data. The hash value is obtained by inputting the original data to a hash function. Examples of hash functions include Secure Hash Algorithm 256-bit (SHA-256) that generates a 256-bit hash value. Hash functions are not limited thereto. Other standardized hash functions and optional unstandardized hash functions are also applicable.

A hash value <1> 413 is calculated based on the block <1> data 402 and the hash value <0> 403 stored in the block 401. The hash value <1> 413 calculated based on the data in the block 401 is stored, together with block <2> data 412, in the following block 411. The block <2> data 412 associates part of division data of the entire data with the block 411.

A hash value <2> 423 is calculated based on the block <2> data 412 and the hash value <1> 413 stored in the block 411. The hash value <2> 423 calculated based on the data in the block 411 is stored, together with block <3> data 422, in the following block 421. The block <3> data 422 associates part of division data of the entire data with the block 421.

A block chain is configured in such a way that the entire data is divided into blocks which are linked in a nested form by using the hash values calculated based on the data of respective blocks. In a block chain, blocks are linked by hash values. Therefore, to alter a certain block in this configuration, it is necessary to alter the hash values of all blocks linked with the block. Alternatively, if a certain block is altered, the hash values of all blocks linked with the block change. This means that a block chain has an advantage that a data alteration is difficult to be performed and also easy to be detected.

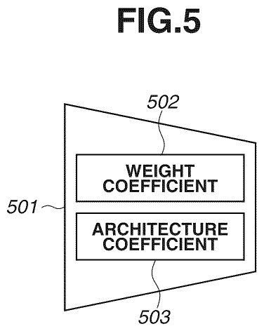

FIG. 5 is a conceptual schematic view illustrating a network model. A network model 501 illustrated in FIG. 5 includes a weight coefficient 502 and an architecture coefficient 503 as configuration information. For example, in a blocking process in step S301 in FIG. 3, the blocking unit 101 divides the data of the network model into a plurality of component units (blocks) of the block chain, for example, in the form of the weight coefficient and the architecture coefficient for each layer.

Referring back to FIG. 3, in step S302, the block chaining unit 105 blockchains the network model having been divided into a plurality of blocks in step S301.

The block chaining unit 105 performs a sequence for reading the data of a block from the first storage unit 104, calculating the hash value of the read block, appending the hash value to the data of the following block, and calculating the hash value. The block chaining unit 105 repetitively performs these operations for the respective blocks to complete the sequence for all blocks. The network model blockchained in this way is held again by the first storage unit 104.

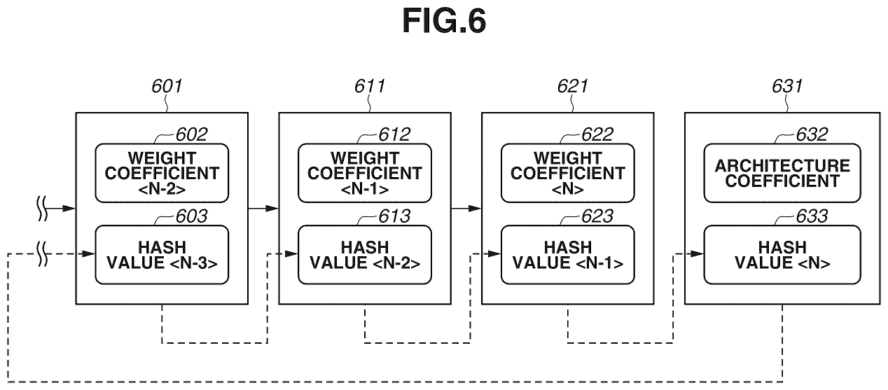

FIG. 6 is a conceptual schematic view illustrating a blockchained network model. FIG. 6 illustrates a state where weight coefficients of three different layers (layers <N−2>, <N−1>, and <N>) and an architecture coefficient of the network model are blockchained.

As illustrated in FIG. 6, a weight coefficient <N−2> 602 of the layer <N−2> and a hash value <N−3> 603 are stored in a block 601. The hash value <N−3> 603 is calculated based on the data of the preceding block linked with the block 601. A hash value <N−2> 613 is calculated by using the weight coefficient <N−2> 602 of the layer <N−2> and the hash value <N−3> 603 stored in the block 601. The hash value <N−2> 613 calculated based on the data in the block 601 is stored, together with a weight coefficient <N−1> 612 of the layer <N−1>, in the following block 611.

Further, a hash value <N−1> 623 is calculated by using the weight coefficient <N−1> 612 of the layer <N−1> and the hash value <N−2> 613 stored in the block 611. The hash value <N−1> 623 calculated based on the data in the block 611 is stored, together with a weight coefficient <N> 622 of the layer <N>, in the following block 621.

A hash value <N> 633 is calculated by using the weight coefficient <N> 622 of the layer <N> and the hash value <N−1> 623 stored in the block 621. The hash value <N> 633 calculated based on the data in the block 621 is stored, together with an architecture coefficient 632, in the following block 631. A network model is blockchained in this way.

In the example illustrated in FIG. 6, the network model having been divided into a plurality of blocks is blockchained so that the blocks are linked in a ring form. When the network model is blockchained in this way, the hash value calculation may be repetitively performed until the hash value change converges in the block chain. The hash value calculation in the block chain may be ended when hash values have been once calculated for all blocks configuring the block chain, for example, when the hash value of the block 631 has been calculated in the example in FIG. 6. If the hash value calculation is to be ended when the hash values have been once calculated for all blocks, for example, the hash value of the last block is stored in the first block or in a predetermined recording area. In a ring-shaped block chain, the hash value calculation may be ended after repeating the hash value calculation a predetermined number of times.

In the example illustrated in FIG. 6, a network model having been divided into a plurality of blocks is blockchained so that the blocks are linked in a ring form. However, the network model may be blockchained so that the blocks are linked in one direction like a common block chain. When a network model is blockchained so that the blocks are linked in one direction, for example, the hash value of the last block needs to be stored in a predetermined recording area. When a network model is blockchained so that the blocks are linked in a ring form, the block chain configuration becomes symmetric, providing an advantage that analysis is difficult.

A weight coefficient or an architecture coefficient, and a hash value are stored in each block as illustrated in FIG. 6, the data stored in each block is not limited thereto. For example, other data such as time information (time stamp) and a nonce value may be stored in each block.

Referring back to FIG. 3, in step S303, the embedded information generation unit 106 generates embedded information based on the hash values of the blocks calculated in step S302. The embedded information generation unit 106 reads the hash values corresponding to respective blocks from the first storage unit 104 and generates information to be embedded in the output of the network model based on the read hash value. How the embedded information is to be embedded depends on the output format of the network model. The embedded information generated in the embedded information generation process in step S303 is output to the second storage unit 107 and held therein.

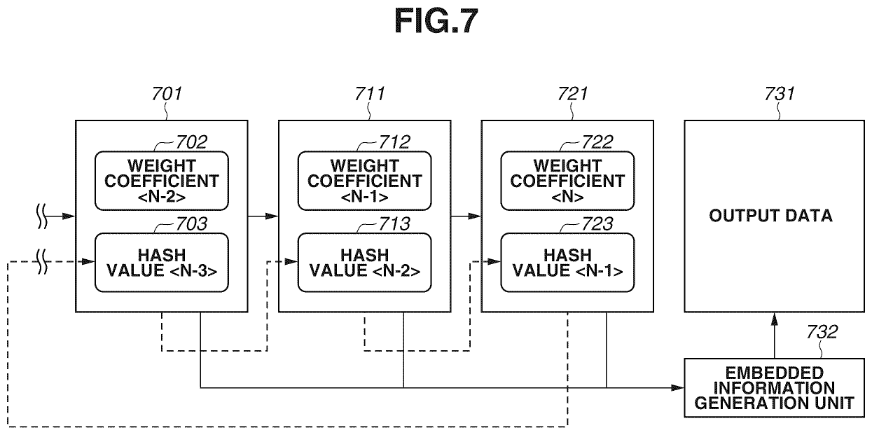

FIG. 7 is a conceptual schematic view illustrating an example of processing such as generating the embedded information. FIG. 7 illustrates a state where the hash values corresponding to respective blocks configuring a block chain are read, and embedded information based on the hash values is embedded in output data 731 from the network model via the embedded information generation unit 732. As described above, the embedded information generation unit 732 generates embedded information depending on the output format of the network model from respective hash values.

As illustrated in FIG. 7, a block 701 stores a weight coefficient <N−2> 702 of the layer <N−2> of the network model and a hash value <N−3> 703. The hash value <N−3> 703 is calculated based on the data of the preceding block linked with the block 701. A hash value <N−2> 713 is calculated by using the weight coefficient <N−2> 702 of the layer <N−2> and the hash value <N−3> 703 stored in the block 701. The hash value <N−2> 713 calculated based on the data in the block 701 is stored, together with a weight coefficient <N−1> 712 of the layer <N−1> of the network model, in the following block 711. At the same time, the hash value <N−2> 713 is embedded in the output data 731 from the network model via the embedded information generation unit 732, as the hash value corresponding to the block 701.

Further, a hash value <N−1> 723 is calculated by using the weight coefficient <N−1> 712 of the layer <N−1> and the hash value <N−2> 713 stored in the block 711. A hash value <N−1> 723 calculated based on the data in the block 711 is stored, together with a weight coefficient <N> 722 of the layer <N> of the network model, in the following block 721. At the same time, the hash value <N−1> 723 is embedded in the output data 731 from the network model via the embedded information generation unit 732, as the hash value corresponding to the block 711. Likewise, the hash value corresponding to block 721 is embedded in the output data 731 from the network model via the embedded information generation unit 732.

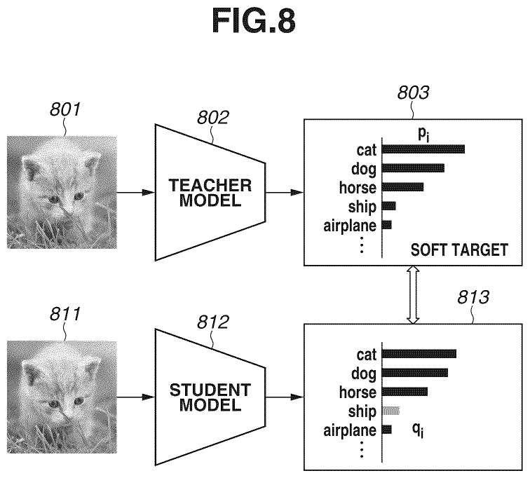

The reason why such embedding in the output of the network model is to be performed will be described below centering on an example case where a network model is misappropriated through distillation learning. FIG. 8 is a conceptual schematic view illustrating distillation learning. FIG. 8 illustrates an example where an image classification model is used as a network model.

Referring to FIG. 8, learning data (image input data) 801 is learning data to be input to a teacher model 802, and learning data 811 is learning data to be input to a student model 812. FIG. 8 illustrates images of cats as examples of pieces of the learning data 801 and 811 as similar data. Generally, a teacher model has a larger scale than a student model. On the other hand, a student model is generally lighter than a teacher model to reduce the implementation cost and calculation cost at the time of deduction.

In this example, the teacher model 802 is a network model to be misappropriated, and the student model 812 is a network model to be learned and generated. The following describes a case where a softmax function with temperature is used as an activation function for the output layers of the teacher model 802 and the student model 812.

FIG. 8 illustrates a distribution pi (soft target) 803 of the output value obtained by inputting the image input data to the teacher model 802. i denotes the number assigned to each class. In the distillation learning, a softmax function with temperature or any one of other functions having a smooth output value distribution is used as an activation function. Therefore, the output value other than the output value (value corresponding to a cat) of the class corresponding to the ground truth class also has a relatively large value. When the temperature setting is T (T>1) and the output value corresponding to the i-th class is T_softmax_i, the softmax function with temperature is represented by Equation 1. ui and uj are input values to the softmax function with temperature corresponding to the i-th and j-th classes, respectively. Referring to Equation 1, the subscript j on the right-hand side denotes the value corresponding to all classes.

$$T\_softmax \_i = \frac{exp ( {u}_{i} / T )}{{\sum }_{j} exp ( {u}_{j} / T )} \qquad ( Equation 1 )$$

The output value (distribution pi) of the softmax function with temperature includes not only information about the class corresponding to the ground truth class but also information about other classes, for example, information held by the teacher model, such as the similarity to the ground truth class. Therefore, even if information about the network model of the teacher model is completely concealed, obtaining the output of the teacher model enables restoring information about the network model of the teacher model to a certain extent through the learning of the student model (described below).

FIG. 8 illustrates a distribution qi 813 of the output values obtained by inputting the image input data to the student model 812. i denotes the number assigned to each class. Generally, when a softmax function with temperature is used as activation functions of the teacher model and the student model, the same temperature as the teacher model is also used for the student model. In the distillation learning, a soft target loss (soft_target_loss) as represented by Equation 2 is calculated based on the output pi of the teacher model and the output qi of the student model. Referring to Equation 2, the subscript i on the right-hand side denotes the value corresponding to all classes.

$$soft\_target \_loss = - {\sum }_{i} {p}_{i} log ( {q}_{i} ) \qquad ( Equation 2 )$$

The output qi of the student model is represented by Equation 3. Referring to Equation 3, vi and vj denote input values to the softmax function with temperature corresponding to the i-th and j-th classes in the student model, respectively. Referring to Equation 3, the subscript j on the right-hand side denotes the value corresponding to all classes.

$${q}_{i} = \frac{exp ( {v}_{i} / T )}{{\sum }_{j} exp ( {v}_{j} / T )} \qquad ( Equation 3 )$$

The learning of the student model 812 is performed based on the soft target loss. Even if the information about the network model of the teacher model is completely concealed, the student model 812 can be newly learned and generated from the output of the teacher model 802 as a misappropriation source network model.

To prevent the misappropriation of the network model through such distillation learning, information known only by a person having the valid right to use the network model is to be embedded in the output of the network model, and the correct output of the network model is to be restored when necessary.

Referring back to FIG. 3, in step S304, the output setting unit 108 embeds the embedded information generated in step S303 in the output data of the network model. The output setting unit 108 reads the embedded information held by the second storage unit 107, embeds the information in the output from the network model, and outputs the output from the network model having the embedded information, as the output data of the network model. The output setting unit 108 embeds the embedded information for respective outputs from the network model for pieces of input data.

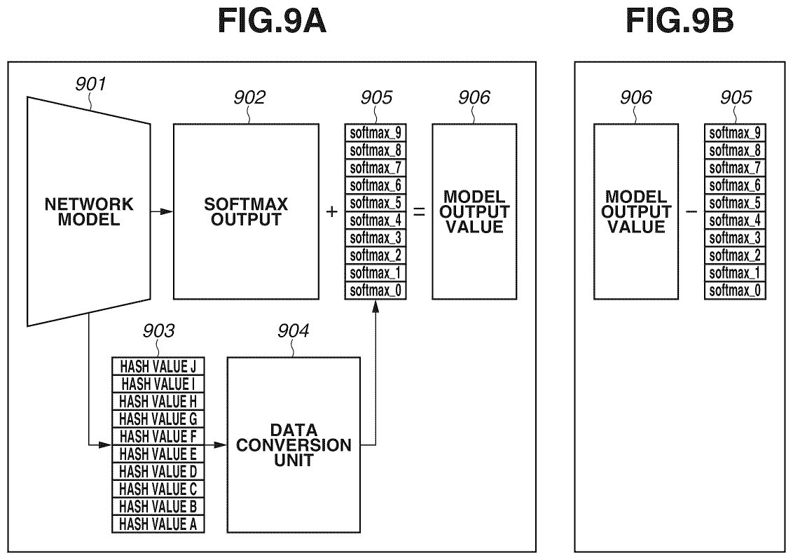

FIGS. 9A and 9B schematically illustrate processing performed to prevent the misappropriation of a network model according to the first exemplary embodiment. The processing is performed in the embedded information generation process in step S303 and the output setting process in step S304 in FIG. 3.

Referring to FIG. 9A, a network model 901 is a network model of a CNN including 12 layers having a classification result output. The network model 901 includes three convolution layers, a pooling layer, three convolution layers, a pooling layer, and four full-connect layers in this order from the input side.

Referring to the examples illustrated in FIGS. 9A and 9B, the network model 901 inputs image data and outputs 10 classification results as a softmax output (output of the softmax function) 902. It is assumed that layers having a weight coefficient (six convolution layers and four full-connect layers) as blocks have been blockchained, and hash values 903 (10 hash values A to J) corresponding to these blocks have been calculated.

A data conversion unit 904 corresponds to the embedded information generation unit 106 which generates the embedded information based on the hash values 903 corresponding to respective blocks. In this example, the data conversion unit 904 inputs the hash values 903, converts the hash values 903 to the output of the softmax function so that the sum total of the output values corresponding to the hash values 903 becomes 1, and generates an output value 905 of the softmax function as embedded information.

The output setting unit 108 adds the value of the softmax output 902 from the network model 901 and the output value 905 of the softmax function as embedded information with ratios of 0.5 to generate an output value 906 of the network model. Generating the output value 906 of the network model in this way enables outputting the output of the network model different from the original output, thus preventing the misappropriation of the network model.

To obtain a correct output value of the network model 901 illustrated in FIG. 9A, (a half of) the embedded softmax function output value 905 is to be subtracted from the output value 906 of the network model, as illustrated in FIG. 9B. The embedded softmax function output value 905 as embedded information can be configured, for example, based on information about the embedded information generation generated, together with the embedded information, by the embedded information generation unit 106.

The output value of the network model is generated in this way. Therefore, even if the distillation learning is performed by using the softmax output of the network model, no valid student model can be learned and generated because the output as the teacher model is different from the original output. The hash values used for the embedded information generation have a nested structure through block chaining and therefore cannot be easily deduced or generated, thus improving the complexity of the embedded information.

The present exemplary embodiment, as described above, can prevent the misappropriation of the network model based on the distillation learning technique using the output of the network model. Dividing parameter data of a network model into a plurality of blocks and blockchaining the blocks enable preventing the alteration of the network model itself in a similar way to the case of using the conventional block chaining. The present exemplary embodiment has an advantage that the security cost does not largely increase even after preventing not only the alteration of the network model itself but also the misappropriation of the network model through the distillation learning.

A second exemplary embodiment will be described below centering on an example where hash values from blockchained blocks are embedded in the feature quantity output of a network model in a predetermined order. Embedding hash values from blockchained blocks in the feature quantity output of the network model in a predetermined order enables preventing the network model from being misappropriated to the distillation learning. Such a feature quantity output is used, for example, to determine whether two different face images are of the same person based on the similarity between the feature quantities, for example, in face recognition.

The configuration and processing of the information processing apparatus 100 according to the second exemplary embodiment are basically the same as those according to the first exemplary embodiment described above with reference to FIGS. 1 to 3, and redundant descriptions thereof will be omitted. According to the second exemplary embodiment, the embedded information generation unit 106 arranges the hash values of blocks obtained by converting the data of respective blocks via the block chaining unit 105, in a predetermined order to generate embedded information. For example, the embedded information generation unit 106 reads the hash values of blockchained blocks from the first storage unit 104 and repetitively arranges the read hash values so that the hash values have the same size as the feature quantity output of the network model to generate embedded information.

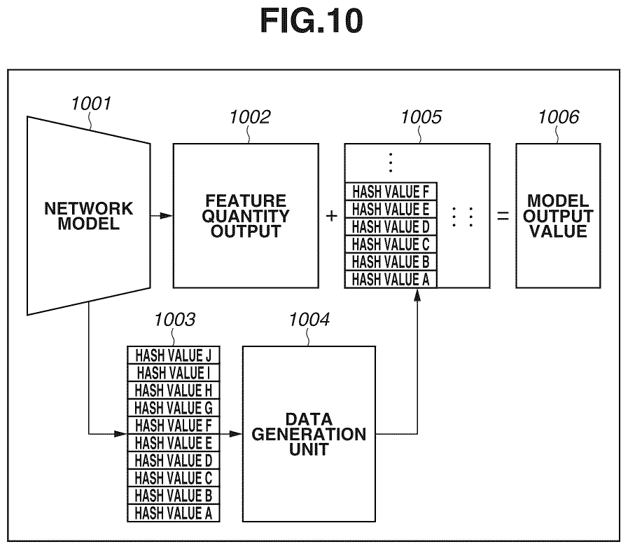

FIG. 10 schematically illustrates processing performed to prevent the misappropriation of a network model according to the second exemplary embodiment. The processing is performed in the embedded information generation process in step S303 and the output setting process in step S304 in FIG. 3.

Referring to the example illustrated in FIG. 10, a network model 1001 inputs image data and outputs the feature quantity as a feature quantity output 1002. The network model 1001 is a network model of a CNN including 12 layers including four convolution layers, a pooling layer, three convolution layers, a pooling layer, and three convolution layers in this order from the input side. It is assumed that layers having a weight coefficient (10 convolution layers) as blocks have been blockchained, and hash values 1003 (10 hash values A to J) corresponding to these blocks have been calculated.

A data generation unit 1004 corresponds to the embedded information generation unit 106 which generates embedded information 1005 by arranging the hash values 1003 corresponding to respective blocks in a predetermined order. Arrangements of the hash values 1003 depend on the degree of complexity of the embedded information to be embedded in the feature quantity output 1002 from the network model. If no conversion is made, the hash values A, B, C, D, . . . , and J are output in this order. When conversion is made to reverse the order, the hash values J, I, H, G, . . . , and A are output in this order. When repeating the arrangement in a predetermined order several times, for example, when the hash values are arranged in normal order, in reverse order, in normal order, and in reverse order, the hash values A, B, C, D, . . . , J, J, I, H, G, . . . , A, A, B, C, D, . . . , J, J, I, H, G, . . . , and A are output in this order.

The embedded information 1005 is generated by arranging the hash values controlled by the data generation unit 1004 so that the hash values have the same size as the feature quantity output 1002 from the network model 1001. For example, if the data generation unit 1004 controls the arrangement so that the hash values A, B, C, D, . . . , and J are arranged in this order, the embedded information 1005 is generated by arranging the hash values A, B, C, D, . . . , J, A, B, C, D, . . . , and J in this order.

When the output setting unit 108 adds the value of the feature quantity output 1002 from the network model 1001 and the value of the embedded information 1005 to generate an output value 1006 of the network model. Generating the output value 1006 of the network model in this way enables outputting the output of the network model different from the original output, thus preventing the misappropriation of the network model.

To obtain a correct output value of the network model 1001 illustrated in FIG. 10, the embedded information 1005 is to be subtracted from the output value 1006 of the network model. The embedded information 1005 can be configured, for example, based on information about the embedded information generation generated, together with the embedded information, by the embedded information generation unit 106.

The output value of the network model is generated in this way. Therefore, even if the distillation learning is performed by using the feature quantity output of the network model, no valid student model can be learned and generated because the output as the teacher model is different from the original output.

The above-described configuration of the present exemplary embodiment can prevent the misappropriation of a network model based on the distillation learning technique using the feature quantity output of the network model. Like the first exemplary embodiment, the present exemplary embodiment can prevent the alteration of the network model itself in a similar way to the case of using the conventional block chaining.

A third exemplary embodiment will be described below centering on an example of an ensemble in which outputs of a plurality of network models are combined. In the following example, in an ensemble (simple average of outputs) of three different network models, hash values from blocks blockchained across the respective network models are embedded in the logits output. Embedding hash values from blockchained blocks in the logits output of a network model enables preventing the misappropriation of the network model by using the distillation learning technique. The logits output is an output before being input to the softmax function. In the following descriptions, each network model includes three different layers to form a 9-classification model.

The configuration and processing of the information processing apparatus 100 according to the third exemplary embodiment are basically the same as those according to the first exemplary embodiment described above with reference to FIGS. 1 to 3, and redundant descriptions thereof will be omitted. According to the third exemplary embodiment, the embedded information generation unit 106 acquires hash values of blocks obtained by converting the data of respective blocks via the block chaining unit 105, and uses the hash values as embedded information. The embedded information generation unit 106 reads the hash values of blocks blockchained across the respective network models from the first storage unit 104 and uses the read hash values as embedded information. The embedded information may be generated by using values having undergone a certain conversion instead of the read hash values as they are.

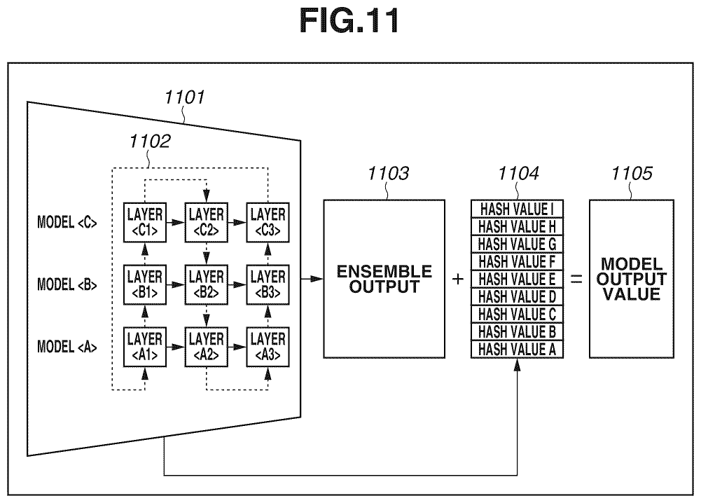

FIG. 11 schematically illustrates processing performed by the information processing apparatus 100 to prevent the misappropriation of a network model according to the third exemplary embodiment.

Referring to the example illustrated in FIG. 11, a network model 1101 include an ensemble of three network models <A>, <B>, and <C>. Each of the network models <A>, <B>, and <C> includes three different full-connect layers to perform nine different classifications by inputting image data and outputting nine different classification results. The format of the input image data is converted into the format of the input full-connect layer.

The network model <A> includes layers <A1>, <A2>, and <A3>, the network model <B> includes layers <B1>, <B2>, and <B3>, and the network model <C> includes layers <C1>, <C2>, and <C3>. In the network model 1101, blockchaining is performed by using weight coefficients and hash values of the respective layers as blocks (3×3=9 blocks).

Referring to FIG. 11, the dotted line 1102 represents a link state of a block chain in the network model 1101. As illustrated in FIG. 11, a link of the block chain is configured across the layers of the network models <A>, <B>, and <C>. Referring to the example illustrated in FIG. 11, the link of the block chain is configured by the layers <A1>, <B1>, <C1>, <C2>, <B2>, <A2>, <A3>, <B3>, <C3>, and <A1> in this order. Configuring the link of the block chain across the layers of the network models <A>, <B>, and <C> in this way enables improving the complexity of the dependencies of the hash values.

An ensemble output 1103 from the network model 1101 can be obtained by an ensemble (simple average) of the outputs of the network models <A>, <B>, and <C>. Embedded information 1104 is generated by the embedded information generation unit 106 based on the hash values corresponding to the respective blocks. In this example, the hash values of the respective blocks (nine hash values A to I) read from the first storage unit 104 are used as they are as the embedded information 1104.

The output setting unit 108 adds the value of the ensemble output 1103 from the network model 1101 and the value of the embedded information 1104 to generate an output value 1105 of the network model 1101. Generating the output value 1105 of the network model 1101 in this way enables outputting an output of the network model 1101 different from the original output, thus preventing the misappropriation of the network model 1101.

To obtain a correct output value of the network model 1101 illustrated in FIG. 11, the embedded information 1104 is to be subtracted from the output value 1105 of the network model 1101. The embedded information 1104 can be configured, for example, based on information about the embedded information generation generated, together with the embedded information, by the embedded information generation unit 106.

The output value of a network model is generated in this way. Therefore, even if the distillation learning is performed by using the logits output of the network model, no valid student model can be learned and generated because the output as the teacher model is different from the original output. A block chain is configured across a plurality of network models. The embedded information to be embedded in the output value of the network model has improved complexity as embedded information, and therefore cannot be easily deduced or generated.

The above-described configuration of the present exemplary embodiment can prevent the misappropriation of a network model based on the distillation learning technique using the logits output of the network model. Like the first exemplary embodiment, the present exemplary embodiment can prevent the alteration of the network model itself in a similar way to the case of using the conventional block chaining.

The first exemplary embodiment embeds the embedded information in the softmax output as an output from a network model. However, the embedded information may be embedded in the logits output before being input to the softmax function like the third exemplary embodiment. The third exemplary embodiment embeds the embedded information in the logits output before being input to the softmax function as the output from the network model. However, the embedded information may be embedded in the softmax output like the first exemplary embodiment.

In the above-described first and third exemplary embodiments, the number of types of classification results coincides with the number of blocks to be blockchained. However, the present disclosure is applicable even if the number of types of classification results is different from the number of blocks to be blockchained. For example, if the number of blocks to be blockchained is less than the number of types of classification results, embedded information is to be generated by redundantly using the hash values of some or all of blocks so that the number of blocks to be blockchained coincides with the number of types of classification results. For example, if the number of blocks to be blockchained is larger than the number of types of classification results, embedded information is to be generated by suitably selecting and using the hash values of blocks so that the number of blocks to be blockchained coincides with the number of types of classification results.

The above-described exemplary embodiments are to be merely considered as illustrative in embodying the present disclosure, and are not to be interpreted as restrictive on the technical scope of the present disclosure. The present disclosure may be embodied in diverse forms without departing from the technical concepts or essential characteristics thereof.

The present disclosure makes it possible to prevent the misappropriation of a network model.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-199426, filed Dec. 14, 2022, which is hereby incorporated by reference herein in its entirety.

What is claimed is:

1. An information processing apparatus comprising:
one or more processors; and
one or more memories that store a computer-readable instruction configured to be executed by the one or more processors, thereby the computer-readable instruction causing the information processing apparatus to:
divide parameter data related to a network model of a neural network into a plurality of blocks, and generate embedded information based on connection information for each block obtained by converting, for the respective blocks, data in each block including the parameter data and connection information for another block; and
perform output setting for using data with the generated embedded information embedded in an output from the network model, as an output of the network model.

2. The information processing apparatus according to claim 1, wherein the parameter is a weight coefficient in the network model and configuration information indicating a configuration of the network model, or the weight coefficient in the network model.

3. The information processing apparatus according to claim 1, wherein the connection information is a hash value obtained by converting data in each block.

4. The information processing apparatus according to claim 1, wherein the one or more processors convert, for the respective blocks, data in each block including the parameter data and connection information for another block into the connection information.

5. The information processing apparatus according to claim 4, wherein the one or more processors convert, for the respective blocks, data in each block including the parameter data and connection information for a preceding block into the connection information to blockchain the plurality of blocks.

6. The information processing apparatus according to claim 5, wherein the one or more processors blockchain blocks corresponding to a plurality of network models divided into a plurality of blocks, across the plurality of the network models.

7. The information processing apparatus according to claim 1,
wherein the network model outputs a classification result, and
wherein the output setting is for use of data with the embedded information embedded in an output indicating the classification result from the network model, as an output of the network model.

8. The information processing apparatus according to claim 7, wherein the output setting is for embedding of the embedded information in a softmax output or a logits output from the network model.

9. The information processing apparatus according to claim 1,
wherein the network model outputs a feature quantity, and
wherein the output setting is for use of data with the embedded information embedded in a feature quantity output from the network model, as an output of the network model.

10. The information processing apparatus according to claim 9, wherein the embedded information is generated by repetitively arranging the connection information for each block in a predetermined order.

11. An information processing method performed by an information processing apparatus, the method comprising:
dividing parameter data related to a network model of a neural network into a plurality of blocks, and generating embedded information based on connection information for each block obtained by converting, for the respective blocks, data in each block including the parameter data and connection information for another block; and
performing output setting for using data with the generated embedded information embedded in an output from the network model, as an output of the network model.

12. A non-transitory computer-readable storage medium that stores a program for causing a computer to:
divide parameter data related to a network model of a neural network into a plurality of blocks, and generate embedded information based on connection information for each block obtained by converting, for the respective blocks, data in each block including the parameter data and connection information for another block; and
perform output setting for using data with the generated embedded information embedded in an output from the network model, as an output of the network model.
